(19) United States
(12) Patent Application Publication
(10) Pub. No.: US 2013/0196294 A1
(43) Pub. Date: Aug. 1, 2013

(54) AUTOMOTIVE TROUBLESHOOTING INSTRUCTOR

(71) Applicant: GANAPATHY LAKSHMANAPERUMAL, PEACHTREE CITY, GA (US)

(72) Inventor: GANAPATHY LAKSHMANAPERUMAL, PEACHTREE CITY, GA (US)

(21) Appl. No.: 13/360,660

(22) Filed: Jan. 28, 2012

(51) Int. Cl. G09B 19/00

(52) U.S. Cl. 434/219

(57) ABSTRACT

A system that provides the automobile user with repair instructions. This is done to help anybody to get step by step repair instructions to do simple fixes themselves. The system can be an electronic device in the vehicle. The system has a library of repair instruction modules which the user can choose from. The system can give text, audio, pictures and video instructions. This system basically helps the end user, by providing instructions to repair the automobile themselves and avoids the need to locate the car manual or to locate a car repair shop for simple do it yourself fixes.

### BACKGROUND OF THE INVENTION

Sometimes a car breakdown happens affecting travel and we do not have a nearby place to take the car for repair. Some of the fixes are simple and can be done by ourselves. But we don't know how to fix it. This invention aims at providing instructions to the user for repairing the automotive vehicle.

### BRIEF SUMMARY OF THE INVENTION

A system that instructs the automobile user with repair instructions is provided. This is done to help anybody to get step by step repair instructions so that they can do simple fixes themselves. The system is an electronic device inside the vehicle. The system has a library of repair instruction modules which the user can choose from. The system can give text, audio, pictures and video instructions. This system basically helps the end user by providing repair instructions and avoids the need to locate the car manual or to locate a car repair shop for simple do it yourself fixes.

### DETAILED DESCRIPTION OF THE INVENTION

This invention aims at providing instructions to the user for repairing an automotive vehicle. Flowchart in FIG. 1 shows processing of data done by the invention.

User is provided with a list of available repair instruction modules which is stored in the internal database. User chooses the module of interest from the list. FIG. 18 shows how the internal database is updated at automobile production. FIG. 2 shows a sample list of repair instruction modules.

The system lists the instruction mode based on the systems human machine interface capability. User selects the instruction mode of interest. The instruction modes supported by the system can be are text, audio, picture and video. FIG. 19 shows the system diagram with the different components of the system. FIG. 3 and FIG. 6 shows the list of available instruction modes for the selected repair module.

This invention requires an electronic control unit with atleast one of the following: 1. Speaker, 2. Display device capable displaying text, 3. Display device capable of displaying image, 4. Display device capable of displaying video.

Instructions are displayed based on the user choice and system capability. FIG. 4 and FIG. 7 shows how text is used in the application to display repair instructions. FIG. 5 and FIG. 8 shows how audio is used in the application to play repair instructions. FIG. 9 to FIG. 16 shows how pictures are used in the application to display repair instructions. FIG. 17 shows how video is used in the application to play repair instructions.

The current implementation is done as an application operating in the automotive cockpit electronic control unit.

The system is inbuilt in the car and does not need external power or internet. In case of some of the existing systems internet or some sort of network connection is required. Chilton's and Haynes also require internet access and a computer to access the data. Even if the user has a smartphone, he needs to have internet access in order to access Chilton's or Haynes. When the car user is in a remote place and does not have access to network, he cannot call his roadside assistance program or go online to check repair instructions. OnStar is satellite based data communication and there are times when the user does not get satellite reception.

In case of some existing systems, OnStar for example involves troubleshooting by using data from on board diagnostics module. This invention does not use diagnostic information or does not involve troubleshooting. It provides the repair instructions the car user needs. These instructions vary from changing tires or changing headlamps. The repair instructions are for obvious issues which the car user faces.

This invention has a custom database with preloaded set of instructions. In case of commercial DIY automobile repair instructions providers the driver needs to know his make, model, car configuration to find the relevant instructions.

OnStar, AllData, Chilton's, Haynes etc are subscription based. This invention is not subscription based. It is available within the car cockpit system as a database.

Chilton's Haynes, AllData provide third party data for repair which might be non-trustable. This invention provides original instructions from car manufacturer.

### BRIEF DESCRIPTION OF DRAWINGS

FIG. 1 Flowchart shows data processing done by the invention

FIG. 2 shows a sample list of repair instruction modules

FIG. 3 shows the list of available instruction modes for one of the sample repair module

FIG. 4 shows how text is used in the application to display repair instructions in one of the sample repair module

FIG. 5 shows how audio is used in the application to play repair instructions in one of the repair module

FIG. 6 shows the list of available instruction modes for a second example repair module

FIG. 7 shows how text is used in the application to display repair instructions in a second repair module

FIG. 8 shows how audio is used in the application to play repair instructions in a second repair module

FIG. 9 to FIG. 16 shows how pictures are used in the application to display repair instructions

FIG. 17 shows how video is used in the application to play repair instructions

FIG. 18 shows how the internal database is updated at automobile production

FIG. 19 shows the system diagram with the different components of the system

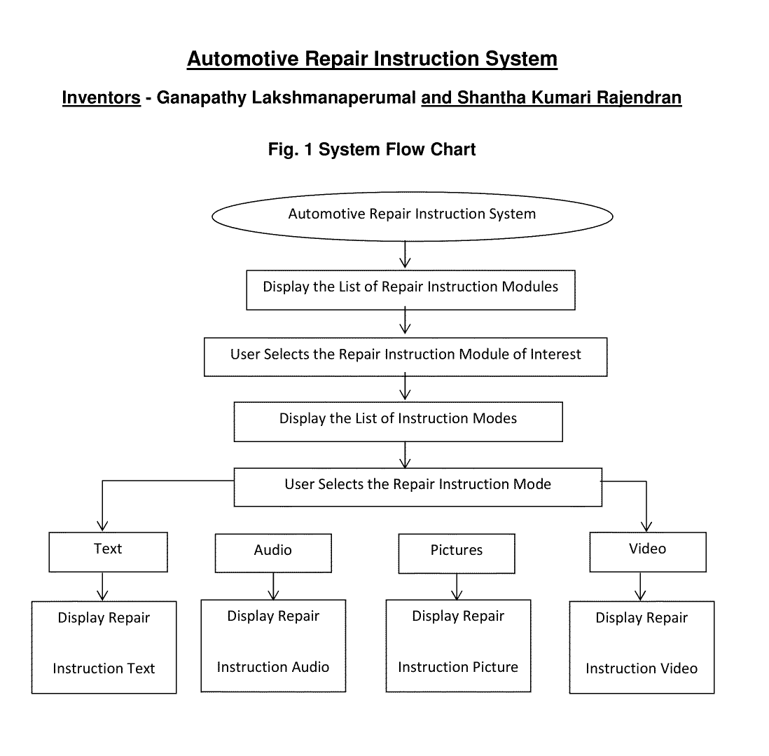

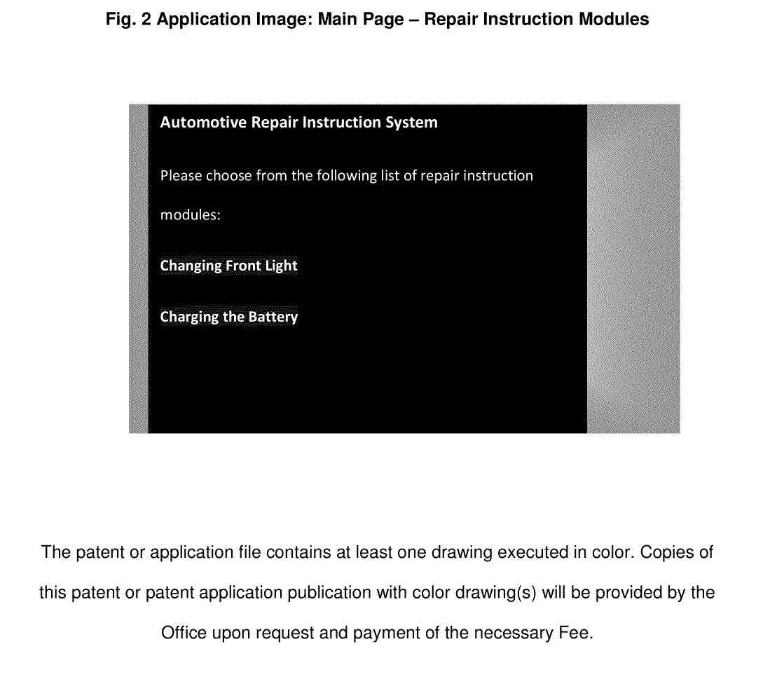

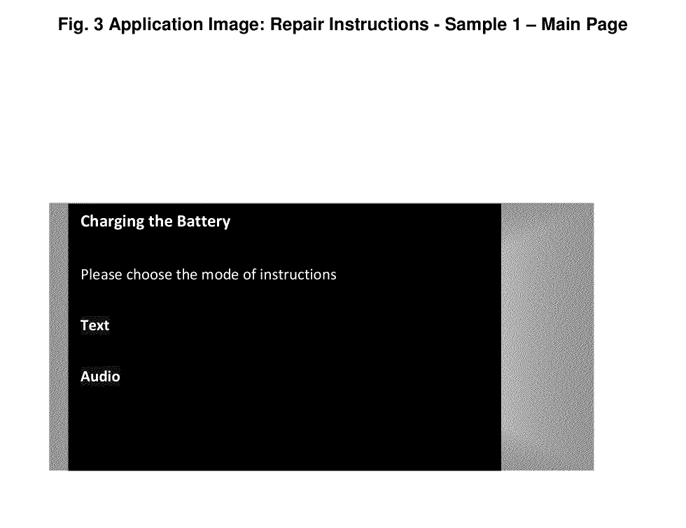

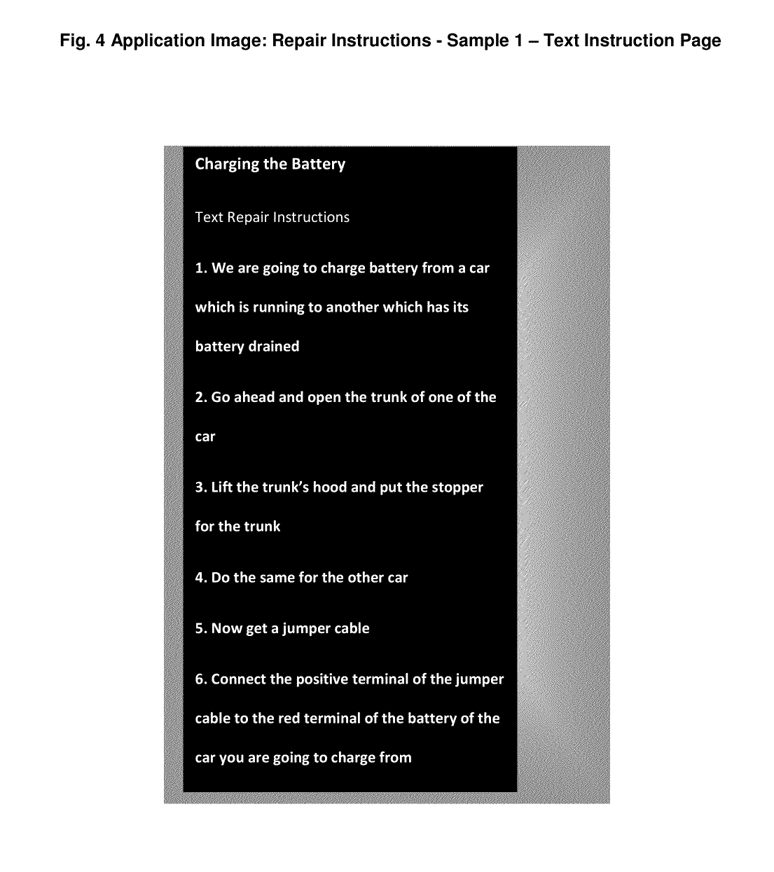

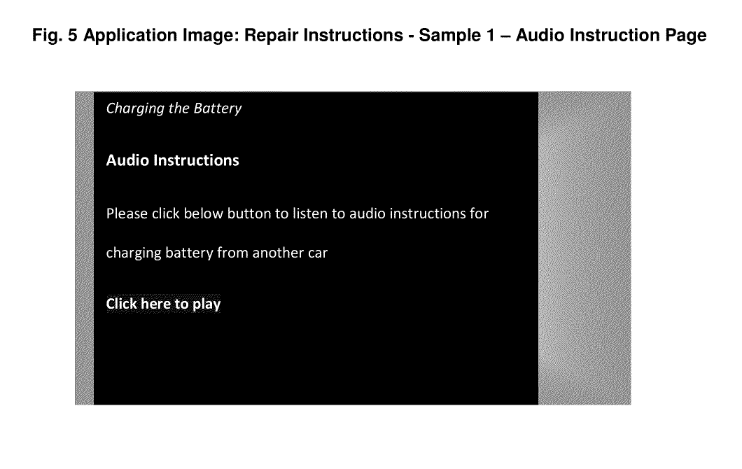

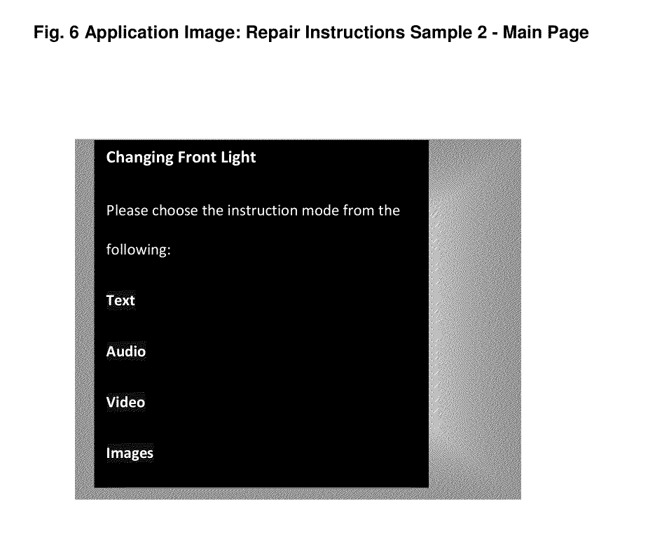

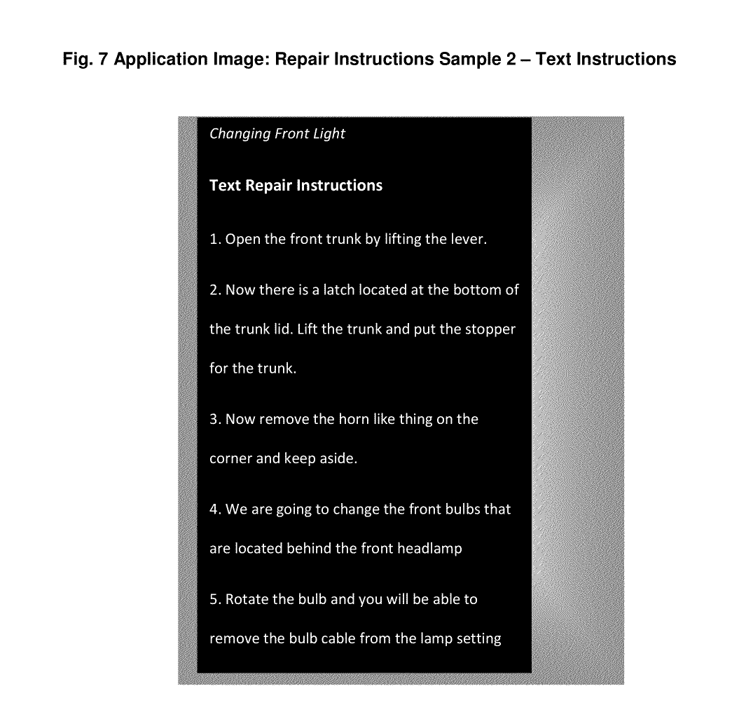

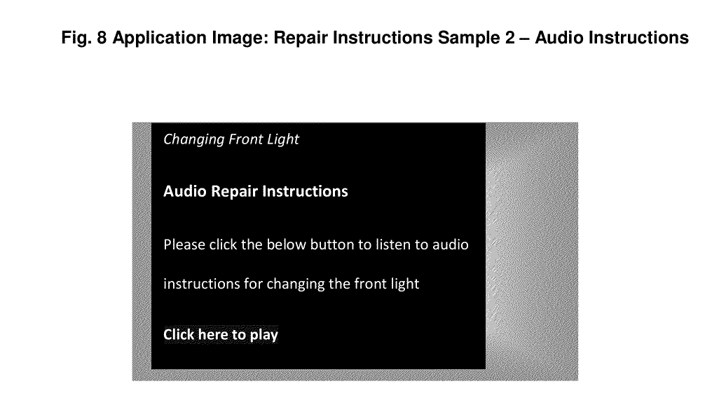

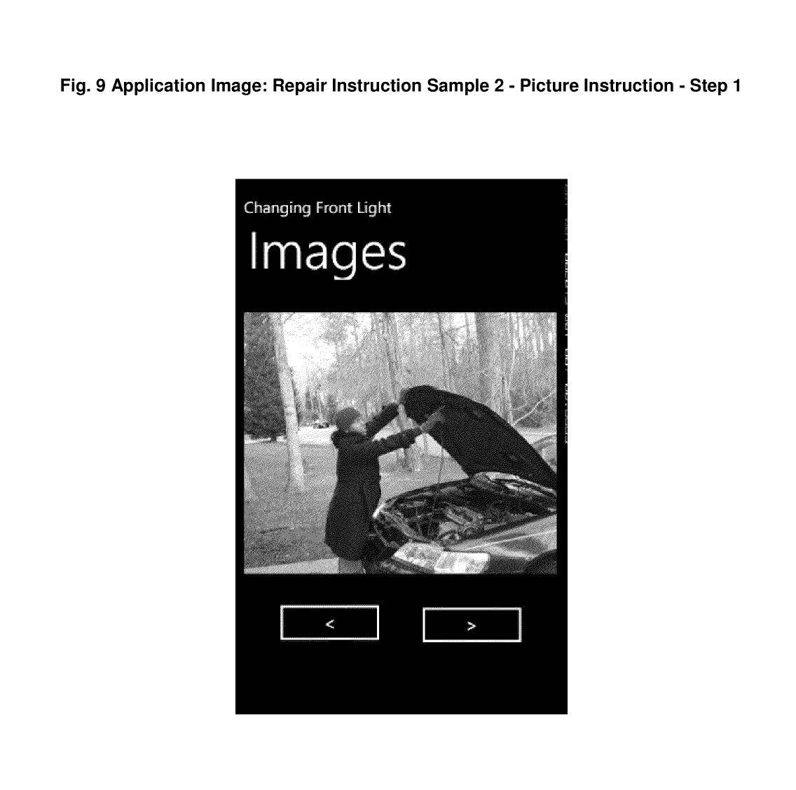

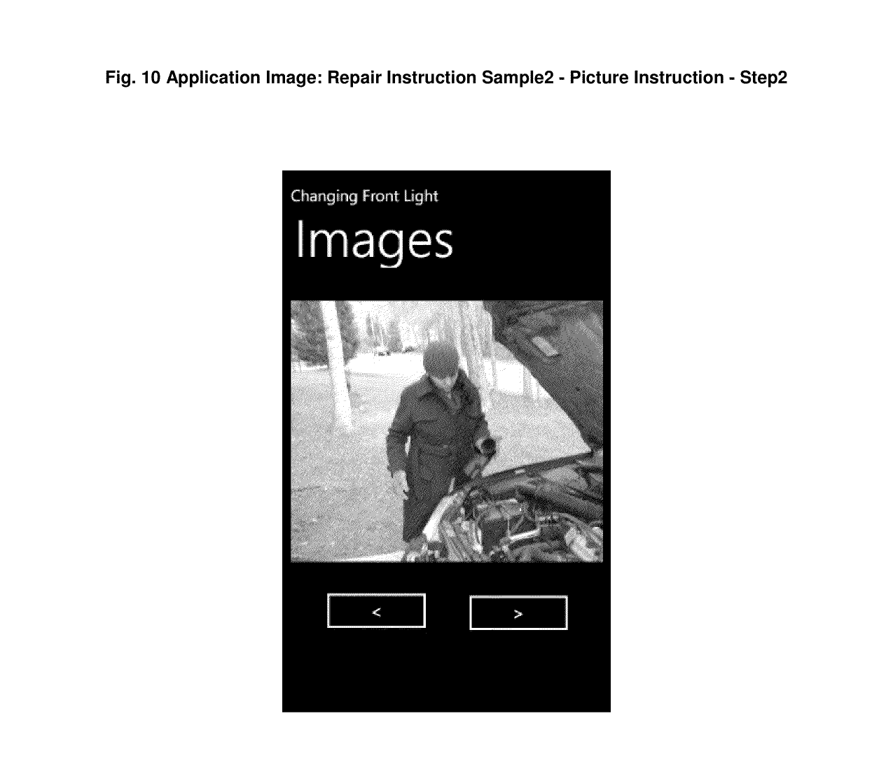

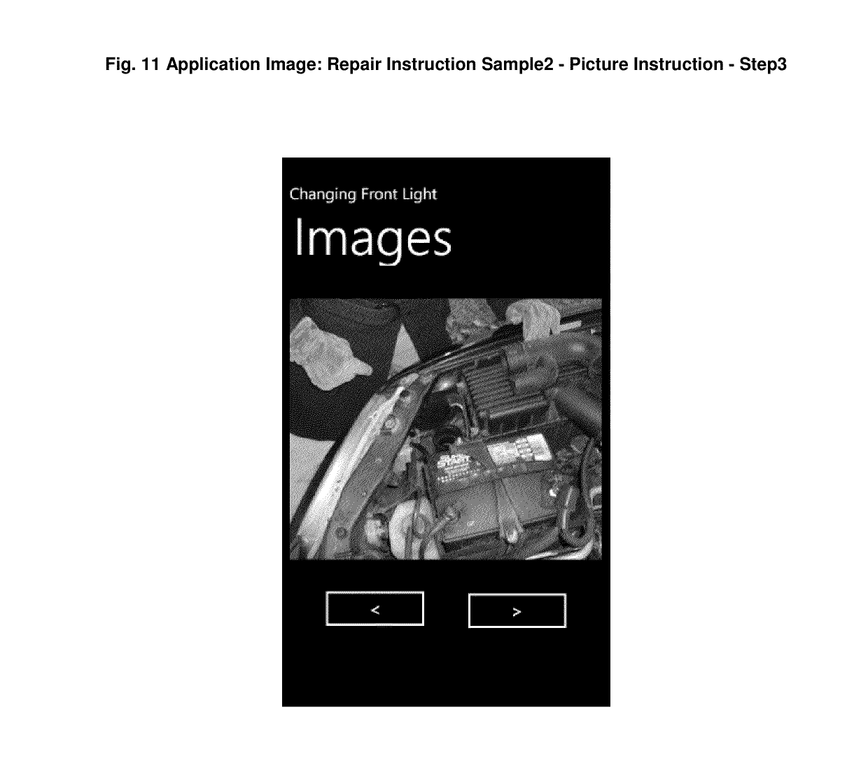

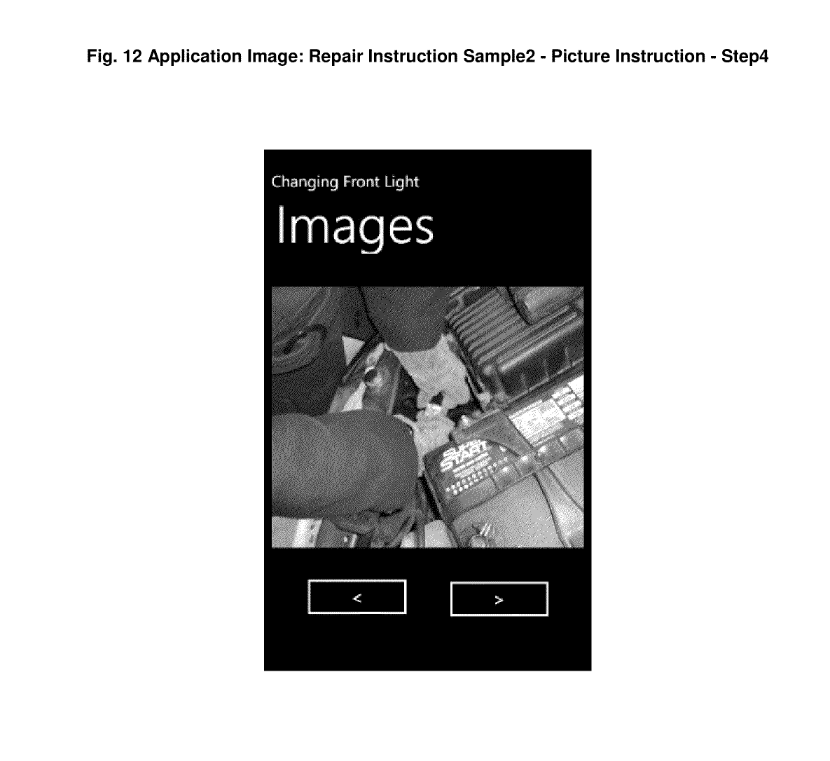

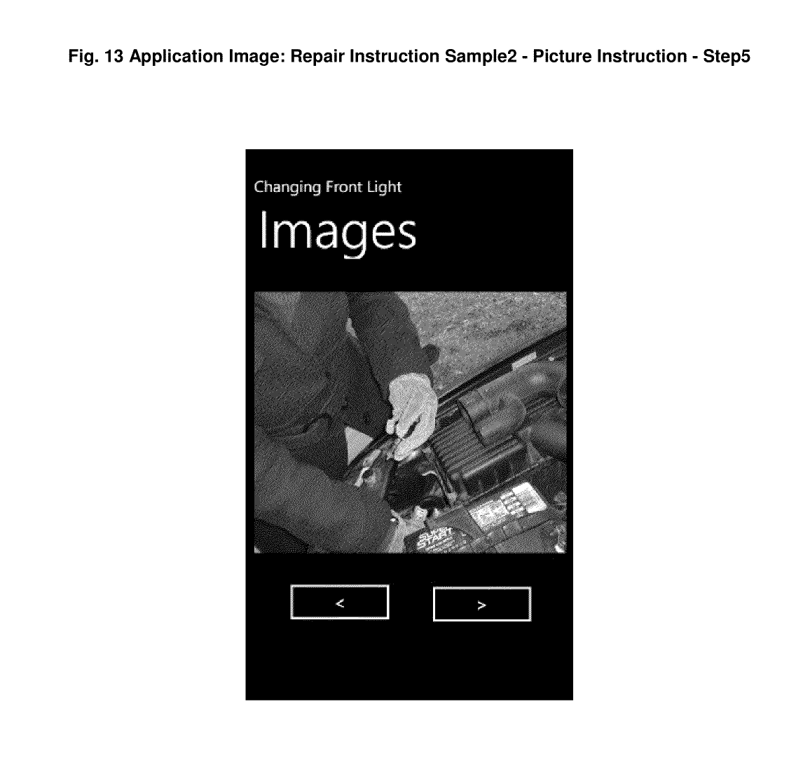

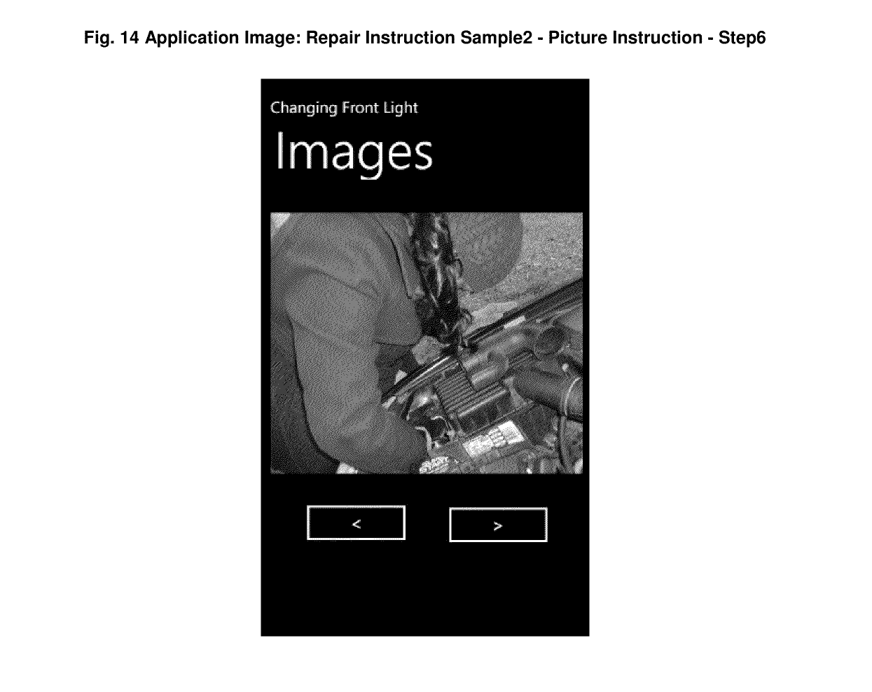

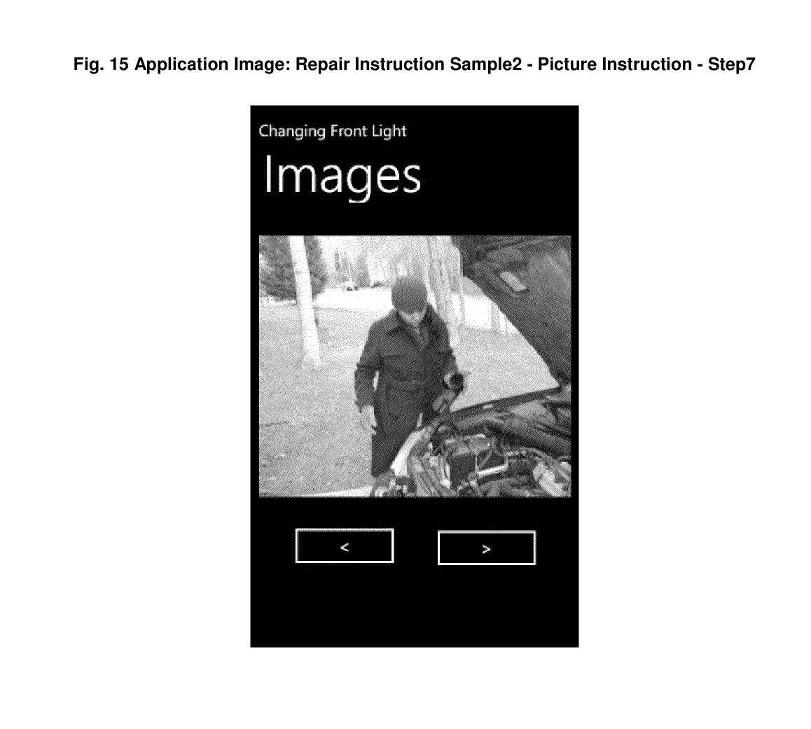

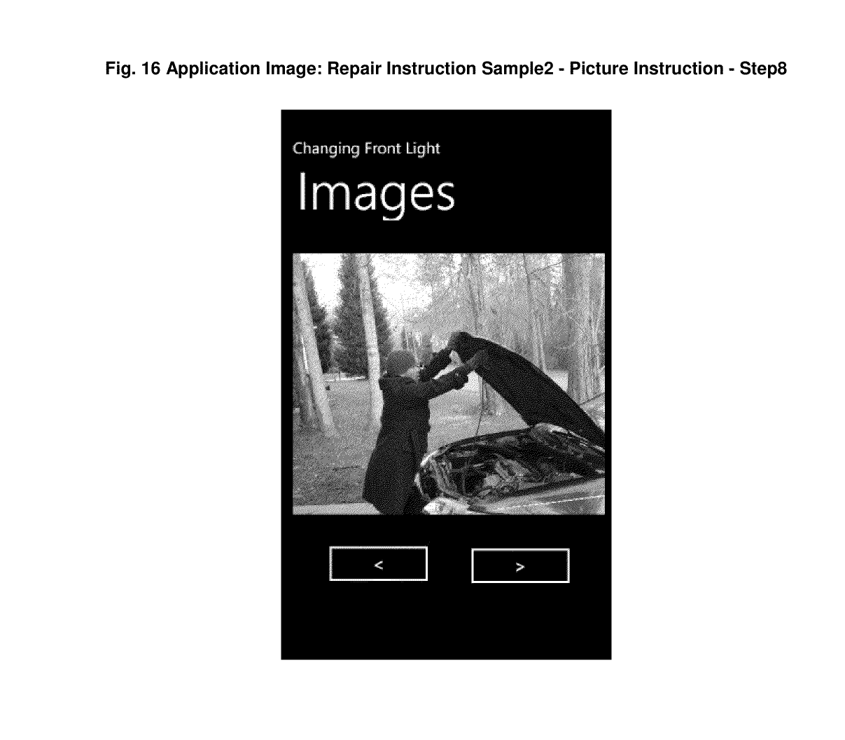

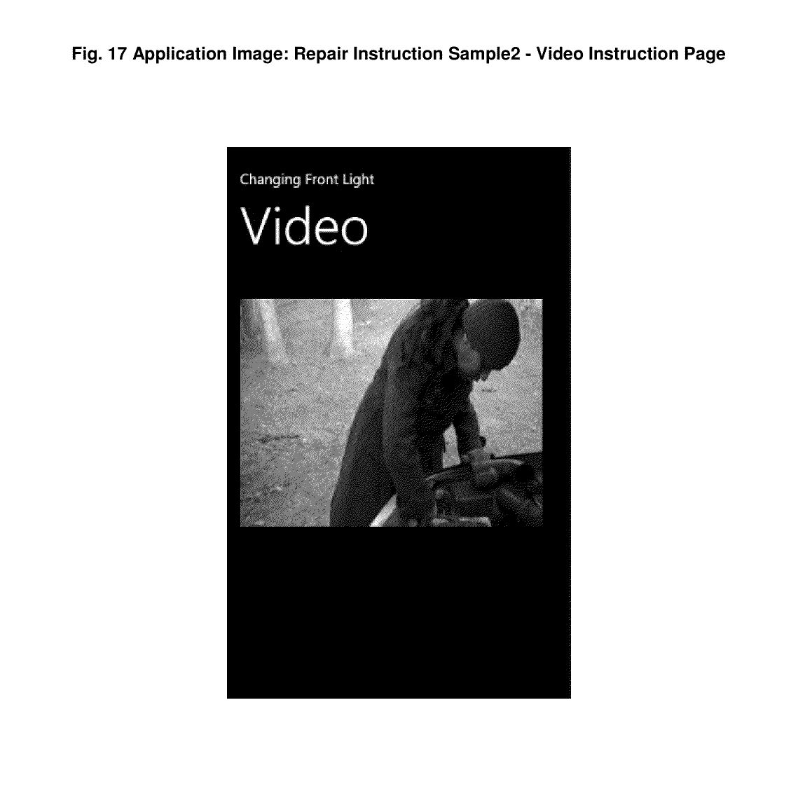

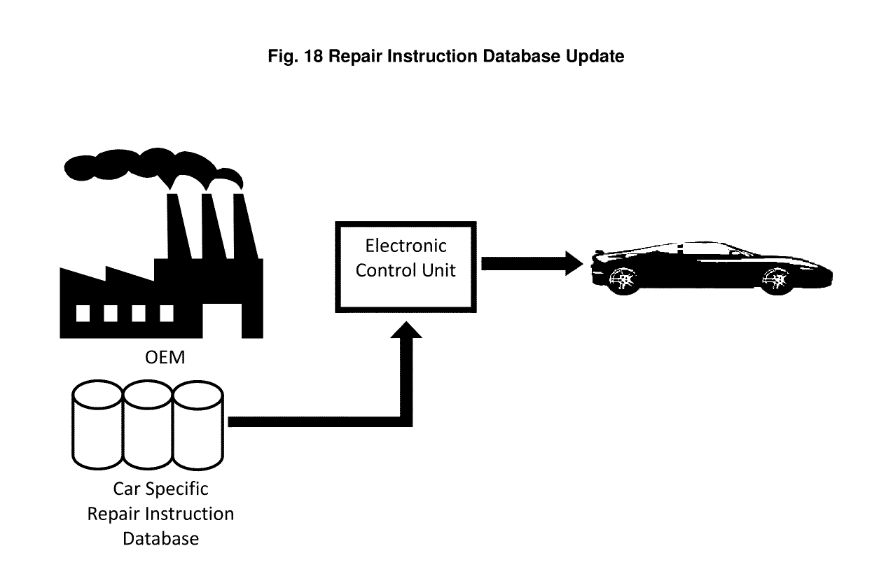

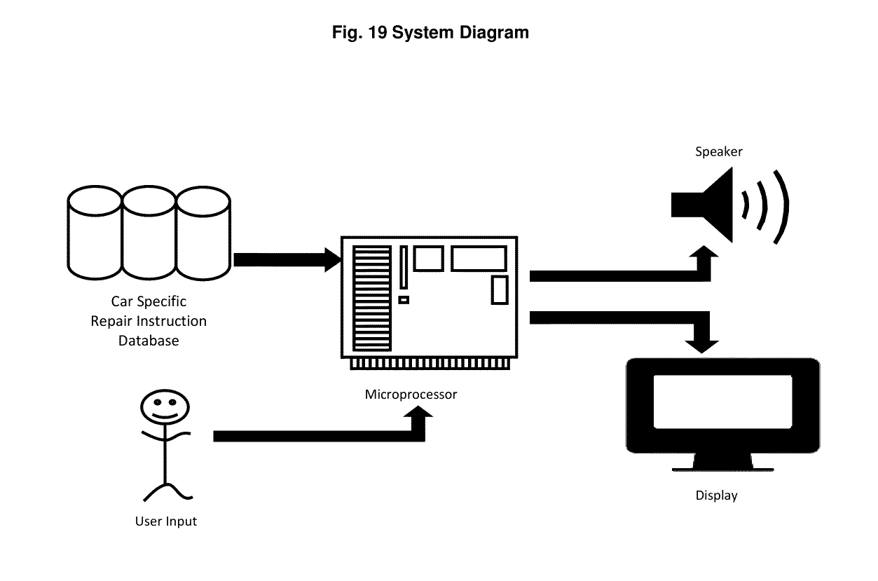

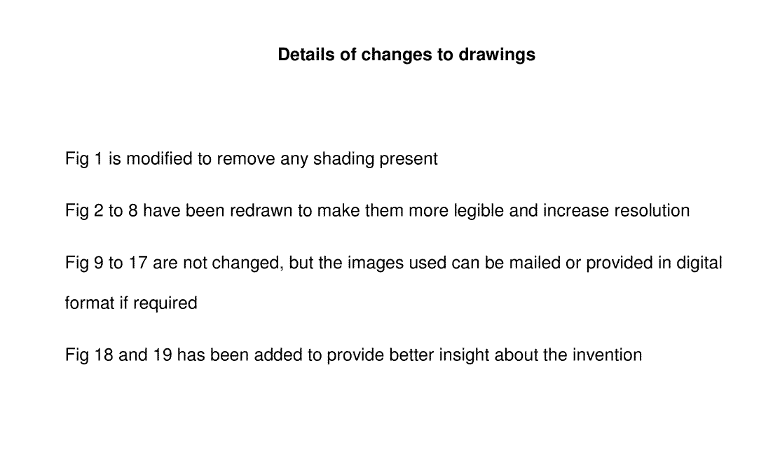

1. A information system, including: a controller device handling user inputs and displaying audio, text, picture, video to the user; a display to output text, picture, video; a speaker to output sound; and an inbuilt database which contains automotive repair instructions.

2. The system of claim 1, in which said database is initially loaded with repair instructions at the automotive OEM

3. A method of informing the driver with repair instructions including the steps of: providing an automotive repair instruction system comprising: a controller device, a display, a speaker, and database; wherein said controller device provides user with the choice of the available repair instruction modules; selecting the repair instruction data from the said database; displaying the repair instructions one by one.
